(19) United States
(12) Patent Application Publication
(10) Pub. No.: US 2024/0036159 A1
(43) Pub. Date: Feb. 1, 2024

(54) PULSE PARAMETER DETECTION FOR RADAR AND COMMUNICATIONS USING TRAINED NEURAL NETWORKS

(71) Applicant: RAYTHEON COMPANY, Waltham, MA (US)

(72) Inventors: Esteban Luis Valles, Los Angeles, CA (US); Andres Ivan Vila Casado, Culver City, CA (US)

(21) Appl. No.: 18/223,688

(22) Filed: Jul. 19, 2023

Related U.S. Application Data
(60) Provisional application No. 63/369,568, filed on Jul. 27, 2022.

(51) Int. Cl. G01S 7/292

(52) U.S. Cl. CPC G01S 7/2928

(57) ABSTRACT

Techniques are described for a computing device to estimate pulse parameters. A method includes (a) receiving a digitized radio frequency (RF) signal as a digital input signal; (b) feeding the digital input signal into a plurality of input nodes of a trained Pulse Parameter Estimation Neural Network (PPENN), the PPENN having been trained using machine learning; (c) operating the trained PPENN to estimate a plurality of pulse parameters of a set of pulses embedded within a waveform of the digital input signal and to output the plurality of pulse parameters from the trained PPENN; and (d) processing the plurality of pulse parameters to further quantify the set of pulses. A system, apparatus, and computer program product for performing this method and similar methods are also described.

### CROSS REFERENCE TO RELATED APPLICATIONS

This application claims priority under 35 USC § 119(e) to U.S. Provisional Patent Application Ser. No. 63/369,568, titled “PULSE PARAMETER DETECTION FOR RADAR AND COMMUNICATIONS USING TRAINED NEURAL NETWORKS,” filed Jul. 27, 2022, which is incorporated by reference herein in its entirety for all purposes.

### BACKGROUND

Radar systems include radio frequency (RF) antennas and receivers to receive RF signals from an environment in order to model various aspects of the environment. Many such radar systems are configured to detect and analyze pulses within received RF signals as part of the environment mapping or analysis. Such pulses may be analyzed to obtain certain pulse parameters, which can be used in many applications including military, security, weather detection and forecasting, traffic enforcement, exploration, mapping, etc.

Certain wireless communications systems may also make use of pulse detection and analysis. For example, spread spectrum systems including CSS and CDMA make use of RF pulses.

Because RF radiation is a common aspect of the world in which we live, it is extremely rare for a RF pulse to be the only RF radiation picked up by a radar receiver. Thus, almost all modern radar and communications systems are configured to account for such noise. Common techniques to account for noise in pulse detection and analysis include filtering using a matched filtering system and thresholding, in which signals below a threshold (absolute) value are ignored.

### SUMMARY

However, conventional radar and communications systems employing filtering and/or thresholding may be deficient in properly detecting desired RF pulses, particularly when the noise level is high. If the levels of noise are as high as or higher than (or even almost as high as) the pulse or pulses being detected, then thresholding will generally not work. Filtering may work in such situations, but the lower the signal-to-noise ratio (SNR), the less likely it is to work. Even if a low-SNR pulse can be detected using filtering, the noise may make it difficult or impossible to accurately ascertain the desired pulse parameters. As the SNR drops below 5 dB, conventional systems begin to lose accuracy and reliability. Below about 0 dB, conventional systems are quite inaccurate, and below −5 dB they are almost worthless. In addition, even if the noise level is not particularly high, when the noise is particularly complex, such as when it results from a rapidly changing complex environment or when the noise changes depending on the signal, conventional filtering and thresholding techniques may also be difficult or impossible to use.

Thus, it would be desirable for a radar or communications system to be able to perform accurate pulse parameter detection even in high noise (low SNR) or complicated noise environments such as environments with a varying noise floor. This may be accomplished by training a neural network to detect pulses and their parameters within a received noisy RF signal. A single neural network may be used to detect several pulse parameters (such as pulse width, pulse start, pulse midpoint, pulse end, pulse amplitude, pulse power, etc.) at once. Such systems may be accurate even in low SNR or complicated noise environments. Accuracy and reliability of such systems may be further improved by pre-filtering the RF signal either using a matched filtering system or by using a second neural network to remove noise and channel effects.

In one embodiment, a method of estimating pulse parameters is described. The method includes (a) receiving a digitized radio frequency (RF) signal as a digital input signal; (b) feeding the digital input signal into a plurality of input nodes of a trained Pulse Parameter Estimation Neural Network (PPENN), the PPENN having been trained using machine learning; (c) operating the trained PPENN to estimate a plurality of pulse parameters of a set of pulses embedded within a waveform of the digital input signal and to output the plurality of pulse parameters from the trained PPENN; and (d) processing the plurality of pulse parameters to further quantify the set of pulses. A system, apparatus, and computer program product for performing this method and similar methods are also described.

### BRIEF DESCRIPTION OF THE DRAWINGS

The foregoing and other objects, features, and advantages will be apparent from the following description of particular embodiments, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates an example system, apparatus, computer program products, and associated data structures for use in connection with one or more embodiments.

FIGS. 2A-2C illustrate example data in accordance with one or more embodiments.

FIGS. 3A-3C illustrate example data in accordance with one or more embodiments.

FIG. 4 illustrates an example method in accordance with one or more embodiments.

### DETAILED DESCRIPTION

Techniques are provided herein for performing accurate pulse parameter detection even in high noise (low SNR) or complicated noise environments in the context of radar systems and communications systems. This may be accomplished by training a neural network to detect pulses and their parameters within a received noisy RF signal. A single neural network may be used to detect several pulse parameters (such as pulse width, pulse start, pulse midpoint, pulse end, pulse amplitude, pulse power, etc.) at once. Such systems may be accurate even in low SNR or complicated noise environments. Accuracy and reliability of such systems may be further improved by pre-filtering the RF signal either using a matched filtering system or by using a second neural network to remove noise and channel effects.

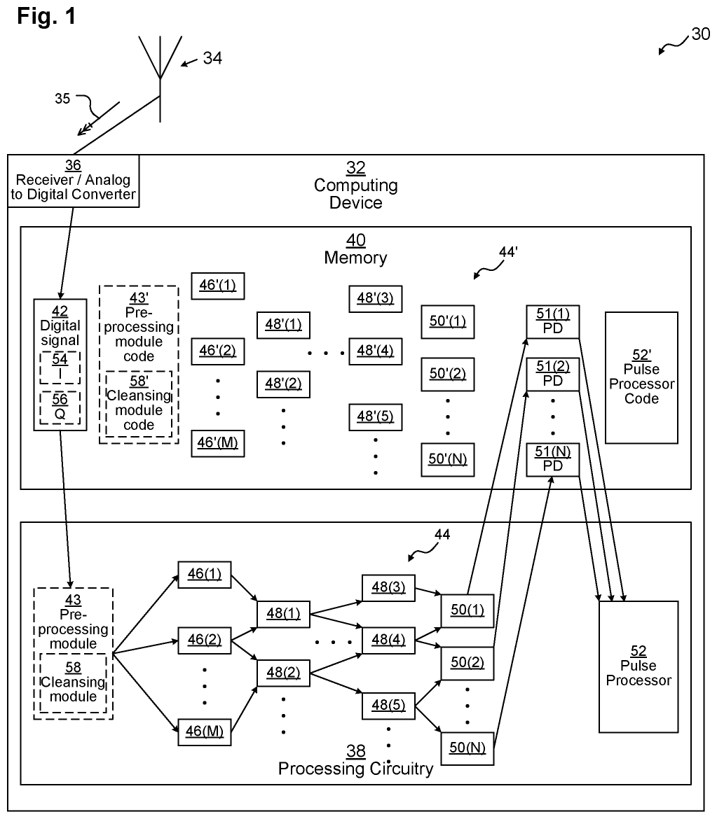

FIG. 1 depicts an example system 30 for use in connection with various embodiments. System 30 includes a client computing device 32 and a radio frequency (RF) antenna 34. Client computing device 32 connects to antenna 34 using a receiver 36. As depicted, receiver 36 includes an analog to digital converter (ADC). Receiver/ADC 36 is configured to receive an electrical signal 35 from the antenna 34 and to output a digital signal 42. In some embodiments, digital signal 42 may be divided into two separate components: an in-phase I component 54 and a quadrature Q component 56.

Computing device 32 may be any kind of computing device, such as, for example, a personal computer, laptop, workstation, server, enterprise server, tablet, smartphone, specialized processing device, etc. In addition to the receiver/ADC 36, computing device 32 includes processing circuitry 38 and memory 40. In some embodiments (not depicted), computing device 36 may also include a transmitter for generating outgoing RF signals to be transmitted by the antenna 34 or by a separate output antenna. Computing device 32 may also include various additional features as is well-known in the art, such as, for example, user interface circuitry, network interface circuitry, interconnection buses, etc.

Processing circuitry 38 may include any kind of processor or set of processors configured to perform operations, such as, for example, a microprocessor, a multi-core microprocessor, a graphics processing unit (GPU), a tensor processing unit (TPU), a field programmable gate array (FPGA), a digital signal processor, a system on a chip (SoC), a specialized collection of electronic circuits, a similar kind of controller, or any combination of the above.

Receiver/ADC 36 may be any kind of circuitry configured to receive electrical signals 35 and to convert them into digital signals 42. In some embodiments, receiver/ADC 36 is configured to treat electrical signals 35 as radar input signals. In other embodiments, receiver/ADC 36 is configured to treat electrical signals 35 as communications signals, such as, for example, wireless communications signals.

Memory 40 may include any kind of digital system memory, such as, for example, random access memory (RAM). It should be understood that although memory 40 is depicted as entirely separate from processing circuitry 38, this is for clarity of illustration only; in actuality, some of the memory 40 may be embedded within the processing circuitry 38, e.g., as registers or cache. Memory 40 may store an operating system (OS, not depicted, e.g., a Linux, UNIX, Windows, MacOS, or similar operating system) and various drivers and other application code and code for software modules configured to execute on processing circuitry 38.

As depicted, memory 40 stores the digital signal 42 received from the receiver/ADC 36, code 44′ for a trained Pulse Parameter Estimation Neural Network (PPENN) 44, and code 52′ for a pulse processor module 52. In some embodiments, memory 40 also stores code 43′ for a pre-processing module 43.

PPENN 44 is a neural network configured to execute on processing circuitry 38 that includes M input nodes 46 (depicted as input nodes 46(1), 46(2), . . . , 46(M)), a plurality of hidden nodes 48 (depicted as hidden nodes 48(1), 48(2), 48(3), 48(4), 48(5), . . .), and N output nodes 50 (depicted as output nodes 50(1), 50(2), . . . , 50(N)). Code 46′, 48′, 50′ for respective input nodes 46, hidden nodes 48, and output nodes 50 is stored in memory 40. Code 46′, 48′, 50′ may include input weights and transfer functions and/or activation functions, for example, for their respective nodes 46, 48, 50. It should be understood that although two layers of hidden nodes 48 have been depicted, any number of hidden layers may be used. In an example embodiment, PPENN 44 is a trained neural network that was trained using machine learning on example input data. In an example embodiment as depicted, each output node 50 outputs a pulse descriptor (PD) 51 (depicted as PDs 51(1), 51(2), . . . , 51(N) stored in memory 40), which is a descriptor of a pulse parameter that describes a pulse or set of pulses embedded in a waveform of the digital signal 42 or one of its components 54, 56. It should be understood that the term “set of pulses” should be understood according to the standard mathematical definition of “set” as referring to zero or more pulses.

In some embodiments, digital signal 42 may be input directly into input nodes 46. For example, in one embodiment, I component 54 may be input into a first input node 46(1) and Q component 56 may be input into a second input node 46(2).

In some embodiments, digital signal 42 may be sampled at discrete intervals. Thus, in one example embodiment, digital signal 42 may include 1,024 samples each taken at a different time, so these 1,024 samples are each input into a separate input node 46 (i.e., M =1,024). In another example embodiment, digital signal 42 may include 1,024 samples for each of the components 54, 56, so these 2,048 samples are each input into a separate input node 46 (i.e., M=2,048). In other example embodiments, other numbers of samples may be used.

In some embodiments, digital signal 42 may be input into a pre-processing module 43 which outputs into input nodes 46. Thus, for example, in one example embodiment, pre-processing module 43 performs a Fourier transformation (or a Fast Fourier Transformation) on the samples of the digital signal to transform it into a frequency domain rather than a time domain. If the Fourier-transformed result has 1,024 samples, then those 1,024 samples are each input into a separate input node 46 (i.e., M=1,024). In another example embodiment, pre-processing module 43 performs a Fourier transformation on both components 54, 56 (e.g., 1024 I component 54 values and 1024 Q component 56 values), yielding twice as many values (e.g., 1024 complex values, so, if each input node 46 can only take either a real or imaginary value, then M=2,048).

In some embodiments, digital signal 42 may be fed directly into input nodes 46 and also be fed into pre-processing module 43 which outputs into other input nodes 46. Thus, in an example embodiment, 1,024 I component values 54, 1,024 Q component values 56, 1,024 Fourier-transformed real component values, and 1,024 Fourier-transformed imaginary component values may all be fed into separate input nodes 46 (i.e., M=4,096).

In some embodiments, pre-processing module 43 may include a cleansing module 58 (with respective code 58′ stored in memory 40) configured to perform a preliminary cleansing operation on the digital input signal 42 in order to remove noise and/or channel effects, such as multi-path, reflections, fades, Doppler effects, etc.

In some embodiments, cleansing module 58 may be implemented as a matched filtering system. In other embodiments, cleansing module 58 may be implemented as a Filtering Neural Network (FiNN). In an example embodiment, a FiNN is a trained neural network that was trained using machine learning on example input data.

PPENN 44 is configured with at least two output nodes 50 (N≥2) so that it outputs at least two PDs 51 that describe a pulse or a set of pulses embedded within a waveform of the digital input signal 42 to pulse processor module 52. Examples of PDs 51 include pulse detection (i.e., is a pulse present?); pulse-on-pulse detection (i.e., are there multiple overlapping pulses?); intrapulse modulation; start time (i.e., what is the beginning time of the pulse?); stop time (i.e., what is the end time of the pulse?); signal power (i.e., what is the area under the pulse?); pulse amplitude; signal-to-noise ratio (i.e., what is the ratio of the power or amplitude of the pulse compared to background noise?); pulse width (i.e., how long between the start and stop time of the pulse?); and center frequency. It should be understood that PPENN 44 does not perform a thresholding operation.

In an example in which a single pulse is embedded within a waveform of the digital input signal 42, the PDs 51 may include the following example data:
PD 51(1) [center frequency]: 2.4 GHz
PD 51(2) [number of pulses]: 1
PD 51(3) [pulse width]: 50 μs
PD 51(4) [SNR]: 15.5 dBm
PD 51(5) [pulse modulation type]: Binary Phase Shift Keying (BPSK)
PD 51(6) [start time]: 2.453 s

In another example in which several pulses are embedded within a waveform of the digital input signal 42, the PDs 51 may include the following example data:
PD 51(1) [center frequency]: 2.4 GHz
PD 51(2) [number of pulses]: 6
PD 51(3) [pulse width]: 50 μs
PD 51(4) [SNR]: 15.5 dBm
PD 51(5) [pulse modulation type]: Binary Phase Shift Keying (BPSK)
PD 51(6) [start time]: 2.453 s
PD 51(7) [pulse repetition interval]: 5.2 μs

In another example in which zero pulses are embedded within a waveform of the digital input signal 42, the PDs 51 may include the following example data:
PD 51(1) [center frequency]: undefined
PD 51(2) [number of pulses]: 0
PD 51(3) [pulse width]: 0 μs
PD 51(4) [SNR]: undefined
PD 51(5) [pulse modulation type]: undefined
PD 51(6) [start time]: undefined
PD 51(7) [pulse repetition interval]: undefined

In some embodiments, it may be possible to detect multiple pulses that each have potentially different parameters. This may be accomplished by including an array of values for some of the PDs 51. For example:
PD 51(1) [number of pulses]: 6
PD 51(2) [pulse width]: [50 μs, 50 μs, 75 μs, 80 μs, 90 μs, 75 μs]
PD 51(3) [SNR]: 1.7 dBm
PD 51(4) [start time]: [1.253411, 1.253471, 1.253536, 1.253630, 1.253745, 1.253835 s]

PPENN 44 may be trained by feeding a neural network having the appropriate number of input nodes 46 and output nodes 50 with example data from a variety of digital input signals 44 ranging from zero noise to very noisy with a variety of types of noise and channel effects. The outputs of the output nodes 50 can be compared to expected truth values and the differences used to modify parameters of the hidden nodes 48 of the neural network using well-known machine learning techniques. In some embodiments, the training may be fully supervised, and in other embodiments, the training may be semi-supervised.

Various neural network designs may be used, such as for example, one-dimensional versions of ResNet50 (using, as an example, approximately 32 million parameters), EfficientNet B7 (using, as an example, approximately 64 million parameters), EfficientNet B0 (using, as an example, approximately 4 million parameters), or MobileNetV3 (using, as an example, approximately 1.5 million parameters).

Pulse processor 52 is configured to process the PDs 51 output by the PPENN 44 to further quantify the pulse embedded within a waveform of the digital input signal 42. For example, pulse processor 52 may perform one or more of pulse deinterleaving, pulse demodulation, target detection, target identification, and various other operations that make use of PDs 51 of a pulse for radar or communications purposes.

Memory 40 may also store various other data structures used by the OS, PPENN 44, modules 43, 52, 58 and various other applications and drivers. In some embodiments, memory 40 may also include a persistent storage portion. Persistent storage portion of memory 40 may be made up of one or more persistent storage devices, such as, for example, magnetic disks, flash drives, solid-state storage drives, or other types of storage drives. Persistent storage portion of memory 40 is configured to store program code and data even while the computing device 32 is powered off. The OS and code 44′, 43′, 52′, 58′ for PPENN 44, modules 43, 52, 58 and various other applications and drivers are typically stored in this persistent storage portion of memory 40 so that they may be loaded into a system portion of memory 40 for execution on processing circuitry 38 upon a system restart or as needed. The OS and code 44′, 43′, 52′, 58′ for PPENN 44, modules 43, 52, 58 and various other applications and drivers, when stored in non-transitory form either in the volatile or persistent portion of memory 40, each form a computer program product. The processing circuitry 38 running one or more of these computer program products thus forms a specialized circuit constructed and arranged to carry out the various processes described herein.

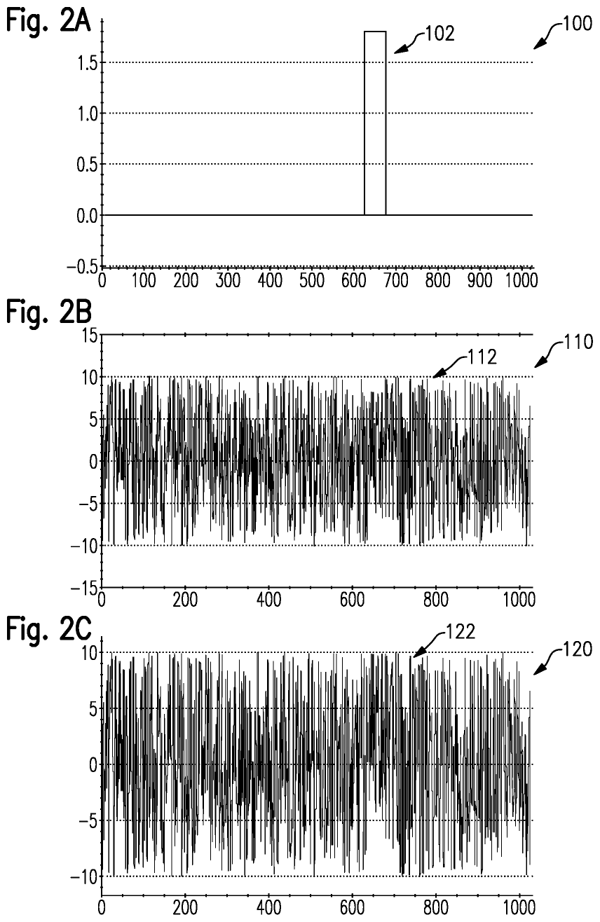

FIG. 2A depicts a graph 100 of an example idealized pulse 102. FIG. 2B depicts a graph 110 of example noise 112. FIG. 2C depicts a graph 120 of a sum 122 of the example idealized pulse 102 and the example noise 112. Sum 122 represents what might be received as digital signal 42 in a real-world scenario representing the idealized pulse 102 when combined with noise from the environment. As depicted, the signal-to-noise ratio (SNR) is quite low, apparently below 0 decibels (dB). Due to the low SNR, conventional techniques, such as thresholding, are generally not able to extract the idealized pulse 102 from the sum 122.

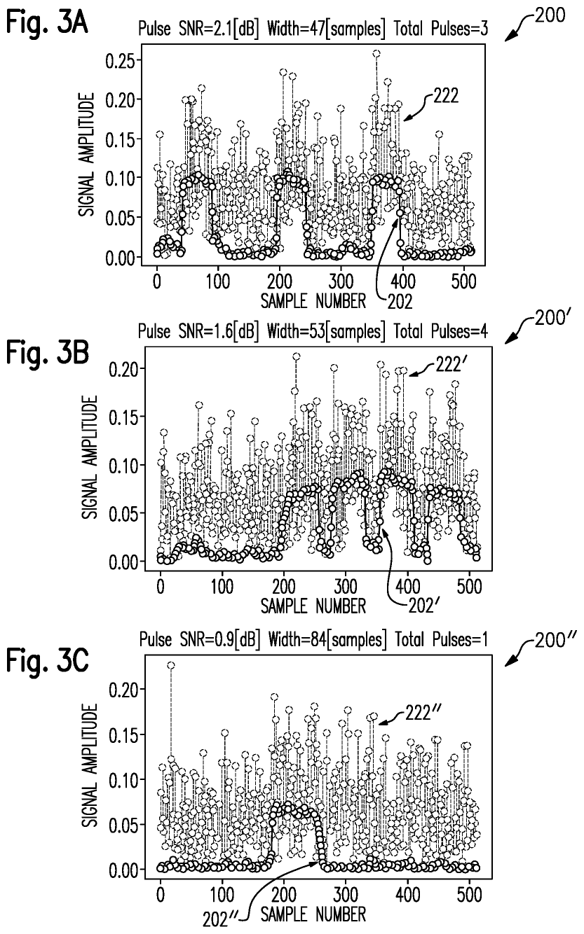

FIG. 3A depicts a graph 200 of an example received noisy signal 222 (dotted lines). Also shown in graph 200 is an underlying example extracted signal 202 (solid lines) representing three pulses with an SNR of 2.1 dB. In the scenario of graph 200, conventional techniques might be able to identify the three pulses using thresholding, but they would likely have trouble accurately determining the start, midpoint, end, amplitude, and width of each pulse.

FIG. 3B depicts a graph 200′ of an example received noisy signal 222′ (dotted lines). Also shown in graph 200′ is an underlying example extracted signal 202′ (solid lines) representing four pulses with an SNR of 1.6 dB. In the scenario of graph 200′, conventional techniques might be able to identify the four pulses using thresholding, but they would be very unlikely to be able to determine the start, midpoint, end, amplitude, and width of each pulse with any degree of accuracy.

FIG. 3C depicts a graph 200″ of an example received noisy signal 222″ (dotted lines). Also shown in graph 200″ is an underlying example extracted signal 202″ (solid lines) representing one pulse with an SNR of 0.9 dB. In the scenario of graph 200″, conventional techniques are unlikely to be able to even identify the pulse using thresholding, and they would again be very unlikely to be able to determine the start, midpoint, end, amplitude, and width of the pulse.

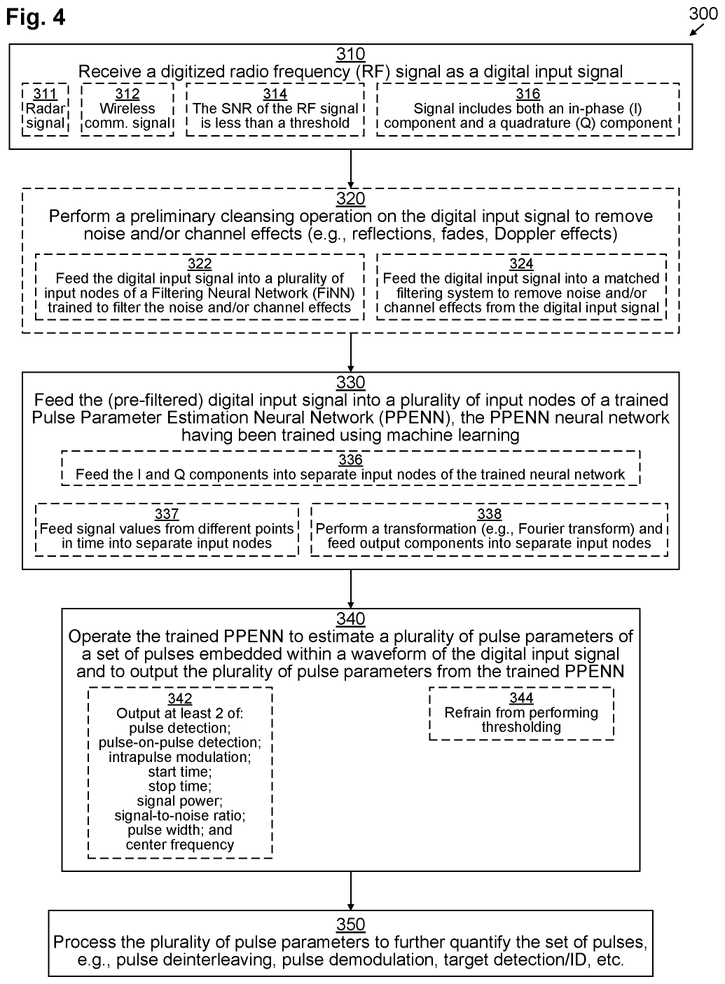

FIG. 4 illustrates an example method 300 performed by a computing device 32 for estimating pulse parameters. It should be understood that any time a piece of software (e.g., OS, modules 43, 52, 58, etc.) is described as performing a method, process, step, or function, what is meant is that a computing device (e.g., computing device 32) on which that piece of software is running performs the method, process, step, or function when executing that piece of software on its processing circuitry 38. It should be understood that one or more of the steps or sub-steps of method 300 may be omitted in some embodiments. Similarly, in some embodiments, one or more steps or sub-steps may be combined together or performed in a different order. Dashed lines indicate that a step or sub-step is either optional or representative of alternate embodiments or use cases.

In step 310, computing device 32 receives a digitized RF signal as a digital input signal 44. In an example embodiment, step 310 includes an antenna 34 picking up an RF signal 35 that is received and digitized by receiver/ADC 36. In some embodiments, step 310 may be implemented as sub-step 311, while in other embodiments, step 310 may be implemented as sub-step 312. In sub-step 311, the RF signal 35 is a radar signal and the antenna 34 and receiver/ADC 36 are optimized for receiving radar signals. In sub-step 312, the RF signal 35 is a wireless communications signal and the antenna 34 and receiver/ADC 36 are optimized for receiving wireless communications signals.

The techniques of method 300 are particularly effective in comparison to conventional techniques, when the SNR is low. Thus, sub-step 314 indicates that the SNR being less than a threshold may be a positive indication to use method 300 rather than another technique. In an example embodiment, the threshold SNR is 0 dB. In other embodiments, a threshold of 5 dB or −5 dB or a value in between may be used instead.

Sub-step 316 indicates that, in some embodiments, digital input signal 44 may be made up of two components, such as an I component 54 and a Q component 56.

In some embodiments, step 320 follows step 310. In step 320, cleansing module 58 performs a preliminary cleansing operation on the digital input signal 44 to remove or reduce noise and/or channel effects, such as reflections, fades, Doppler effects, etc. In one embodiment, step 320 includes sub-step 322 in which cleansing module 58 feeds the digital input signal 44 into a plurality of input nodes of a FiNN that has been trained (e.g., using machine learning) to filter out at least some noise and/or channel effects. In another embodiment step 320 includes sub-step 324 in which cleansing module 58 feeds the digital input signal 44 into a matched filtering system to remove or reduce the noise and/or channel effects from the digital input signal 44.

In step 330, computing device 32 feeds the (optionally pre-filtered, see step 320) digital input signal 44 into a plurality of input nodes 46 of a trained PPENN 44, the PPENN 44 having been trained using machine learning. Depending on the embodiment, step 330 may include one or more of sub-steps 336, 337, 338.

In sub-step 336, computing device 32 feeds the I and Q components 54, 56 into separate input nodes 46 of the PPENN 44.

In sub-step 336, computing device 32 feeds signal values from different points in time (e.g., 1,024 samples) into separate input nodes 337.

In sub-step 337, pre-processing module 43 performs a transformation (e.g., a Fourier Transformation) on the (optionally pre-filtered) digital input signal 44, and then computing device 32 feeds signal values from the transformed signal (e.g., 1,024 samples) into separate input nodes 46.

In step 340, PPENN 44 operates to estimate a plurality of pulse parameters of a pulse 102 or set of pulses 202, 202′. 202″ embedded within a waveform of the digital input signal 44 and to output the plurality of pulse parameters from the trained PPENN 44 as PDs 51 from output nodes 50.

In sub-step 342, PPENN 44 outputs at least two of the following into separate output nodes 50: pulse detection (i.e., is a pulse present?); pulse-on-pulse detection (i.e., are there multiple overlapping pulses?); intrapulse modulation; start time (i.e., what is the beginning time of the pulse?); stop time (i.e., what is the end time of the pulse?); signal power (i.e., what is the area under the pulse?); signal-to-noise ratio (i.e., what is the ratio of the power or amplitude of the pulse compared to background noise?); pulse width (i.e., how long between the start and stop time of the pulse?); and center frequency. Sub-step 344 clarifies that PPENN 44 does not perform thresholding as part of step 340.

Finally, in step 350, pulse processor 52 processes the plurality of PDs 51 output via output nodes 50 to further quantify the pulse 102 or set of pulses 202, 202′, 202″, e.g., by performing pulse deinterleaving, pulse demodulation, target detection, target identification, etc.

Thus, techniques have been provided for performing accurate pulse parameter detection even in high noise (low SNR) or complicated noise environments in the context of radar systems and communications systems. This may be accomplished by training a PPENN 44 to detect a pulse 102 or set of pulses 202, 202′, 202″ and their parameters within a received noisy RF signal 42. A single neural network 44 may be used to detect several PDs 51 (such as pulse width, pulse start, pulse midpoint, pulse end, pulse amplitude, pulse power, etc.) at once in output nodes 50. Accuracy and reliability of such systems may be further improved by pre-filtering the RF signal 42 either using a matched filtering system or by using a second neural network to remove noise and channel effects.

Such systems may be accurate even in low SNR environments. In experimental use of a system as described herein, the pulse detection error was observed to be approximately 0% for input signals 42 having an SNR down to about 0 dB. At −5 dB, the pulse detection error was observed to be approximately 4%. The balanced F-score (F₁) for pulse detection was observed to be 0.997 for SNR values as low as −5 dB. The balanced F-score (F₁) for pulse detection was observed to be 0.989 for SNR values as low as −11 dB.

The mean error for pulse count estimation was approximately 0% for input signals 42 having an SNR down to about 0 dB. At −5 dB, the mean error for pulse count estimation was observed to be just below 0.2. The mean error for pulse width estimation was less than 0.05% for input signals 42 having an SNR down to about 0 dB. At −10 dB, the mean error for pulse width estimation was observed to be just below 0.2%. The mean error for pulse start estimation was less than 0.1% for input signals 42 having an SNR down to about 0 dB. At −10 dB, the mean error for pulse start estimation was observed to be less than 0.8%.

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicants make no admission that such technique, method, apparatus, or other concept is actually prior art under 35 U.S.C. § 102 or 103, such determination being a legal determination that depends upon many factors, not all of which are known to Applicants at this time.

What is claimed is:

1. A method of estimating pulse parameters, the method comprising:
receiving a digitized radio frequency (RF) signal as a digital input signal;
feeding the digital input signal into a plurality of input nodes of a trained Pulse Parameter Estimation Neural Network (PPENN), the PPENN having been trained using machine learning;
operating the trained PPENN to estimate a plurality of pulse parameters of a set of pulses embedded within a waveform of the digital input signal and to output the plurality of pulse parameters from the trained PPENN; and
processing the plurality of pulse parameters to further quantify the set of pulses.

2. The method of claim 1 wherein:
the digital input signal includes both an in-phase (I) component and a quadrature (Q) component; and
feeding the digital input signal into a plurality of input nodes includes feeding the I and Q components into separate input nodes of the trained PPENN.

3. The method of claim 2 wherein:
the RF signal is a radar signal; and
processing the plurality of pulse parameters to further quantify the set of pulses includes performing pulse deinterleaving.

4. The method of claim 1 wherein:
a signal-to-noise ratio (SNR) of the RF signal is less than a predetermined threshold value; and
operating the trained PPENN to estimate the plurality of pulse parameters does not include performing thresholding.

5. The method of claim 1 wherein the method further comprises, prior to feeding the digital input signal into the plurality of input nodes of the PPENN, performing a preliminary cleansing operation on the digital input signal to remove noise or channel effects.

6. The method of claim 5 wherein performing the preliminary cleansing operation includes feeding the digital input signal into another plurality of input nodes of a Filtering Neural Network (FiNN) that was trained to filter noise from the digital input signal, the FiNN being configured to output into the plurality of input nodes of the trained PPENN.

7. The method of claim 1 wherein operating the trained neural network to output the plurality of pulse parameters from the trained neural network includes outputting at least two of:
pulse detection;
pulse-on-pulse detection;
intrapulse modulation;
start time;
stop time;
signal power;
signal-to-noise ratio;
pulse width; and
center frequency.

8. A system comprising:
a radio frequency (RF) antenna configured to receive an RF signal;
an analog-to-digital converter configured to digitize the received RF signal to yield a digital input signal; and
processing circuitry configured to:
feed the digital input signal into a plurality of input nodes of a trained Pulse Parameter Estimation Neural Network (PPENN), the PPENN having been trained using machine learning;
operate the trained PPENN to estimate a plurality of pulse parameters of a set of pulses embedded within a waveform of the digital input signal and to output the plurality of pulse parameters from the trained PPENN; and
process the plurality of pulse parameters to further quantify the set of pulses.

9. The system of claim 8 wherein:
the digital input signal includes both an in-phase (I) component and a quadrature (Q) component; and
feeding the digital input signal into a plurality of input nodes includes feeding the I and Q components into separate input nodes of the trained PPENN.

10. The system of claim 9 wherein:
the RF signal is a radar signal; and
processing the plurality of pulse parameters to further quantify the set of pulses includes performing pulse deinterleaving.

11. The system of claim 8 wherein:
a signal-to-noise ratio (SNR) of the RF signal is less than a predetermined threshold value; and
operating the trained PPENN to estimate the plurality of pulse parameters does not include performing thresholding.

12. The system of claim 8 wherein the processing circuitry is further configured to, prior to feeding the digital input signal into the plurality of input nodes of the PPENN, perform a preliminary cleansing operation on the digital input signal to remove noise or channel effects.

13. The system of claim 12 wherein performing the preliminary cleansing operation includes feeding the digital input signal into another plurality of input nodes of a Filtering Neural Network (FiNN) that was trained to filter noise from the digital input signal, the FiNN being configured to output into the plurality of input nodes of the trained PPENN.

14. A computer program product comprising a non-transitory computer-readable storage medium storing a set of instructions, which, when performed by a computing device, causes the computing device to:
receive a digitized radio frequency (RF) signal as a digital input signal;
feed the digital input signal into a plurality of input nodes of a trained Pulse Parameter Estimation Neural Network (PPENN), the PPENN having been trained using machine learning;
operate the trained PPENN to estimate a plurality of pulse parameters of a set of pulses embedded within a waveform of the digital input signal and to output the plurality of pulse parameters from the trained PPENN; and
process the plurality of pulse parameters to further quantify the set of pulses.

15. The computer program product of claim 14 wherein:
the digital input signal includes both an in-phase (I) component and a quadrature (Q) component; and
feeding the digital input signal into a plurality of input nodes includes feeding the I and Q components into separate input nodes of the trained PPENN.

16. The computer program product of claim 15 wherein:
the RF signal is a radar signal; and
processing the plurality of pulse parameters to further quantify the set of pulses includes performing pulse deinterleaving.

17. The computer program product of claim 14 wherein:
a signal-to-noise ratio (SNR) of the RF signal is less than a predetermined threshold value; and
operating the trained PPENN to estimate the plurality of pulse parameters does not include performing thresholding.

18. The computer program product of claim 14 wherein the set of instructions, when performed by the computing device, further causes the computing device to, prior to feeding the digital input signal into the plurality of input nodes of the PPENN, perform a preliminary cleansing operation on the digital input signal to remove noise or channel effects.

19. The computer program product of claim 18 wherein performing the preliminary cleansing operation includes feeding the digital input signal into another plurality of input nodes of a Filtering Neural Network (FiNN) that was trained to filter noise from the digital input signal, the FiNN being configured to output into the plurality of input nodes of the trained PPENN.

20. The computer program product of claim 14 wherein operating the trained neural network to output the plurality of pulse parameters from the trained neural network includes outputting at least two of:
pulse detection;
pulse-on-pulse detection;
intrapulse modulation;
start time;
stop time;
signal power;
signal-to-noise ratio;
pulse width; and
center frequency.
